(19) United States
(12) Patent Application Publication
(10) Pub. No.: US 2021/0097865 A1
(43) Pub. Date: Apr. 1, 2021

(54) WARNING METHOD AND SYSTEM FOR VEHICLE DEVIATION, VEHICLE, AND STORAGE MEDIUM

(71) Applicant: SZ DJI TECHNOLOGY CO., LTD., Shenzhen (CN)

(72) Inventor: Mingyu WANG, Shenzhen (CN)

(21) Appl. No.: 17/118,538

(22) Filed: Dec. 10, 2020

Related U.S. Application Data
(63) Continuation of application No. PCT/CN2018/108045, filed on Sep. 27, 2018.

(51) Int. Cl. G08G 1/16; G06K 9/00

(52) U.S. Cl. CPC G08G 1/167; G06K 9/00798

(57) ABSTRACT

The present disclosure provides a method for vehicle deviation warning. The method includes obtaining vibration data when a vehicle vibrates; determining whether the vehicle deviated from a driving lane based on the vibration data; and issuing a warning signal if the vehicle deviated from the driving lane.

### CROSS-REFERENCE TO RELATED APPLICATION

This application is a continuation application of International Application No. PCT/CN2018/108045, filed on Sep. 27, 2018, the entire content of which is incorporated herein by reference.

### TECHNICAL FIELD

The present disclosure relates to the field of driving assistance technology and, more specifically, to a warning method and system for vehicle deviation, a vehicle, and a storage medium.

### BACKGROUND

With the development of driving assistance technology, more and more vehicles are equipped with lane departure warning systems. When the vehicle driven by the driver departs from the normal driving lane, the lane departure warning system would send a warning signal to the driver.

The lane departure warning system often uses visual sensors, such as cameras to collect lane marking images in real time, and uses image processing technology to determine the position of the vehicle in the driving lane, thereby determining whether the vehicle deviated from the normal driving lane.

However, visual sensors, such as cameras, are easily affected by the external environment. For example, when there is rain or snow, or a lane with low visibility, the visual sensors will not be able to accurately collect lane marking images, which will cause the lane departure warning system to fail to accurately provide warning of the vehicle deviation.

### SUMMARY

One aspect of the present disclosure provides a method for vehicle deviation warning. The method includes obtaining vibration data when a vehicle vibrates; determining whether the vehicle deviated from a driving lane based on the vibration data; and issuing a warning signal if the vehicle deviated from the driving lane.

Another aspect of the present disclosure provides a vehicle deviation warning system. The vehicle deviation warning system includes a processor; and a memory storing program programs. When executed by the processor, the programs cause the processor to: obtain vibration data when a vehicle vibrates; determine whether the vehicle deviated from a driving lane based on the vibration data; and issue a warning signal if the vehicle deviated from the driving lane.

Another aspect of the present disclosure provides a device for vehicle driving assistance. The device includes a processor; and a memory storing computer programs that, when executed by the processor, causes the processor to: obtain vibration data when a vehicle vibrates; and determine whether the vehicle deviated from a driving lane based on the vibration data.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a warning method for vehicle deviation according to an embodiment of the present disclosure.

FIG. 2 is a schematic diagram of an application scenario according to an embodiment of the present disclosure.

FIG. 3 is a flowchart of the warning method for vehicle deviation according to another embodiment of the present disclosure.

FIG. 4 is a schematic diagram of another application scenario according to an embodiment of the present disclosure.

FIG. 5 is a schematic diagram of yet another application scenario according to an embodiment of the present disclosure.

FIG. 6 is a flowchart of the warning method for vehicle deviation according to another embodiment of the present disclosure.

FIG. 7 is a structural diagram of a warning system for vehicle deviation according to an embodiment of the present disclosure.

### REFERENCE NUMERALS

### 20 Vehicle

21 Lane line

### 22 Protrusion

70 Warning system

### 71 Memory

### 72 Processor

73 Inertial measurement device
74 Visual sensor

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

It should be noted that, when one component is referred to as “fixed to” another component, it may be directly on another component or it is also possible that there is a third component between them. When one component is considered to “connect” another component, it may be directly connected to the other component or it is possible that there is a third component between them.

Unless otherwise defined, all the technical and scientific terms used herein have the same meanings generally understood by persons skilled in the technical field of the present disclosure. Herein, the terms used in the specification of the present disclosure are intended to describe specific embodiments, instead of limiting the present disclosure. The term “and/or” used herein includes any combination and all combinations of one or more related items listed.

Some implementation modes of the present disclosure are described below in detail in combination with the accompanying drawings. Where there is no conflict, the following embodiments and features in the embodiments can be combined with each other.

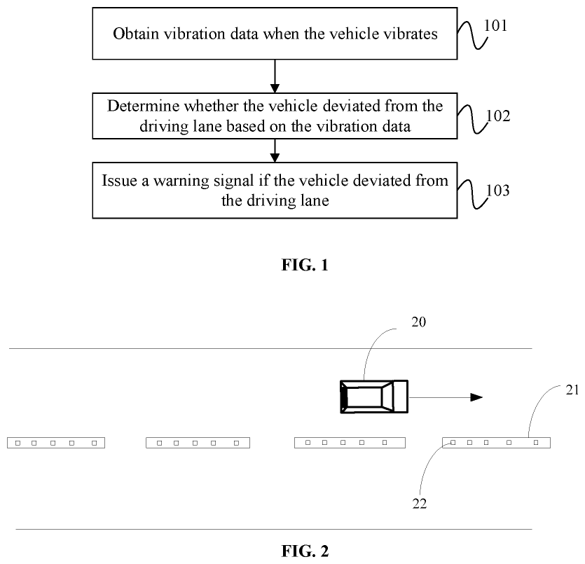

An embodiment of the present disclosure provides a warning method for vehicle deviation. FIG. 1 is a flowchart of a warning method for vehicle deviation according to an embodiment of the present disclosure. The warning method for vehicle deviation will be described in detail below.

101, obtaining vibration data when the vehicle vibrates.

As shown in FIG. 2, a vehicle 20 is moving in the lane. The vehicle 20 can be a vehicle with an automatic driving system or a vehicle with an assisted driving system. The vehicle 20 may include an inertial measurement device, and the inertial measurement device can be used to detect the acceleration and attitude of the vehicle 20 in the three-axis directions. In addition, the vehicle 20 may further include a warning system, which can be used to detect whether the vehicle 20 deviated from the lane line, and send a warning signal when the vehicle 20 deviated from the lane line.

As shown in FIG. 2, reference numeral 21 represents the lane line in the lane. In this embodiment, a plurality of protrusions 22 are disposed on the lane line 21, and the interval between adjacent protrusions 22 may be the same or different. That is, the protrusions 22 may be disposed at equal intervals, or the protrusions 22 may be disposed at unequal intervals. In addition, reflective tapes may also be disposed between adjacent protrusions 22, or a reflective tape may be disposed on the lane line 21 and protrusions may be disposed on the reflective tape. The reflective tape is used to remind the driver to follow the lane line instructions at night, and not to press the lane line. This is only a schematic description, and does not limit the arrangement of the protrusions on the lane line.

It should be understood that when the wheel of the vehicle 20 is in contact with the protrusions on the lane line, it means that the vehicle 20 has deviated from the lane line. At this time, the vehicle 20 will vibrate. However, if there is a shallow pit or a speed bump in the lane, the vehicle 20 may also vibrate when the wheel of the vehicle 20 makes contact with the shallow pit or the speed bump. That is, there may be more than one reason for the vehicle 20 to vibrate.

In some embodiments, obtaining the vibrate data when the vehicle vibrates may include determining the vibrate data when the vehicle vibrates based on a detection signal of the inertial measurement device on the vehicle.

For example, the warning system installed in the vehicle 20 may specifically include a processor for data processing, and a prompt device capable of providing warning, such as a display a buzzer, etc. The inertial measurement device installed in the vehicle 20 can be used to detect the acceleration and attitude of the vehicle 20 in the three-axis directions in real time. Correspondingly, the processor may be in communication connection with the inertial measurement device, and the processor may be configured to obtain the detection signal of the inertial measurement device in real time. In some embodiments, the inertial measurement device may be disposed on a suspension of the vehicle wheel. In other embodiments, the inertial measurement device is not limited to being disposed on the suspension of the vehicle wheel, and the inertial measurement device may also be disposed in other positions of the vehicle.

In addition, in other embodiments, after the processor obtains the detection signal of the inertial measurement device in real time, the processor may perform signal processing on the detection signal, such as amplification, filtering, removing bottom noise, etc. It can be understood that when the vehicle 20 vibrates, the processor can determine the vibration data when the vehicle 20 vibrates based on the detection signal of the inertial measurement device. The vibration data may include the amplitude, frequency, time, and other information of the vibration of the vehicle 20.

102, determining whether the vehicle deviated from the driving lane based on the vibration data.

It can be understood that compared with the wheel of the vehicle 20 being in contact with the shallow pit or the speed bump, when the wheel of the vehicle 20 contacts the lane line, the vibration data determined by the processor based on the detection signal of the inertial measurement device may be different, such as different vibration amplitudes and different vibration frequencies. Correspondingly, based on the vibration data of the vehicle 20, the processor may determine whether the vehicle 20 is driving through a shallow pit or a speed bump, of whether the vehicle 20 is driving against the lane line.

103, issuing a warning signal if the vehicle deviated from the driving lane.

If the processor determines that the vehicle 20 is driving against the lane line, it means that the vehicle 20 has deviated from the lane line, then the processor can send a control signal to the prompt device of the warning system, such as a display, a buzzer, etc. As such, the prompt device can send out a warning signal. For example, the display may display the warning information of the vehicle deviating from the driving lane, or the buzzer may buzz to remind the driver that the vehicle is deviating from the driving lane.

In some embodiments, if the processors determines that the 20 is driving on the lane line based on the vibration data of the vehicle 20, the processor may further determine whether the left wheel or the right wheel of the vehicle 20 is driving on lane line based on the vibration data. If the left wheel of the vehicle 20 is driving on the lane line, the processor can send a control signal to the warning device of the warning system, such as a display, a buzzer, etc., such that the warning device can send a warning signal that the left wheel is pressing the lane line. Similarly, if the left right of the vehicle 20 is driving on the lane line, the processor can send a control signal to the warning device of the warning system, such as a display, a buzzer, etc., such that the warning device can send a warning signal that the right wheel is pressing the lane line

In this embodiment, the vehicle's warning system can obtain vibration data when the vehicle is vibrating, and based on the vibration data, determine whether the vehicle deviated from the driving lane. Since there are protrusions on the lane line corresponding to the lane where the vehicle is positioned, when the vehicle is in contact with the protrusions, it means that the vehicle has deviated from the driving lane, and a warning signal can be issued at this time. Since the warning system obtaining the vibration data when the vehicle vibrates is not affected by the weather, when there is rain or snow or a lane with low visibility, the warning system can still obtain the vibration data of the vehicle normally to determine whether the vehicle is deviating from the driving lane, thereby improving the warning accuracy of the warning system for vehicles deviating from the driving lane.

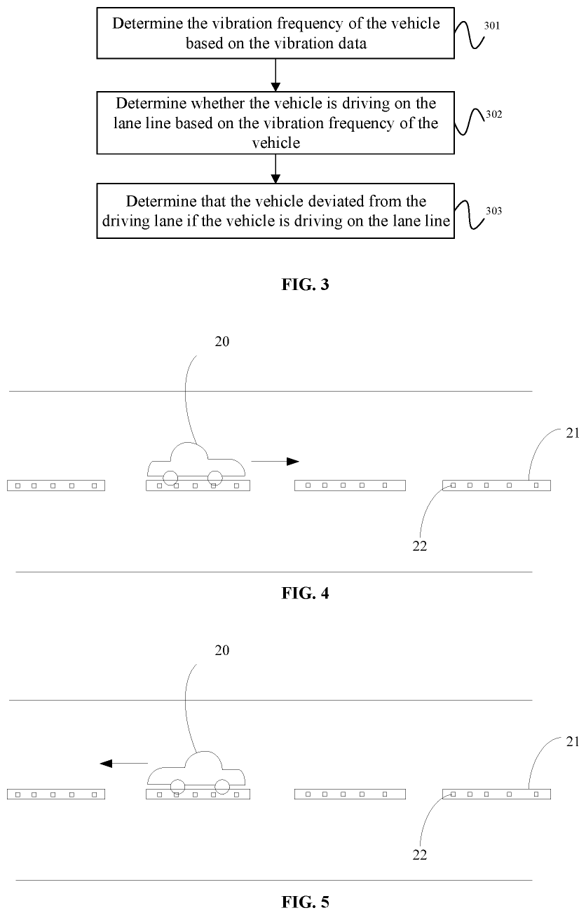

An embodiment of the present disclosure provides a warning system for vehicle deviation. FIG. 3 is a flowchart of the warning method for vehicle deviation according to another embodiment of the present disclosure. As shown in FIG. 3, on the basis of the embodiment shown in FIG. 1, determining whether the vehicle deviated from the driving lane based on the vibration data may include:

301, determining the vibration frequency of the vehicle based on the vibration data.

For example, when the processor in the warning system of the vehicle 20 obtains the detection signal of the inertial measurement device, and determines the vibration data when the vehicle 20 vibrates based on the detection signal, the vibration frequency of the vehicle 20 may be determined based on the vibration data.

302, determining whether the vehicle is driving on the lane line based on the vibration frequency of the vehicle.

In this embodiment, if the vehicle 20 is driving on a lane line with protrusions, the 20 may vibrate within a certain frequency range, and the vibration may occur at the two wheels on one side of the vehicle 20. For example, if the two wheels on the right side of the vehicle 20 are driving on the lane line with protrusions, the vibration amplitude of the two wheels on the right side of the vehicle 20 may be greater than the vibration amplitude of the two wheels on the left side of the vehicle 20. Alternatively, the vibration frequency of the two wheels on the right side of the vehicle 20 may be greater than the vibration frequency of the two wheels on the left side of the vehicle 20.

Determining whether the vehicle is driving on the lane line based on the vibration frequency of the vehicle may include determining that the vehicle is driving on the lane line if the vibration frequency of the vehicle is within a predetermined frequency range.

For example, the protrusions on the lane line are disposed at equal intervals, therefore, when the vehicle 20 is driving on the lane line, the vibration frequency of the vehicle 20 may remain with the predetermined frequency range. Correspondingly, if the processor determines that the vibration frequency of the vehicle 20 is within the predetermined frequency range based on the vibration frequency of the vehicle 20, the processor may determine that the vehicle 20 is driving on the lane line.

303, determining that the vehicle deviated from the driving lane if the vehicle is driving on the lane line.

When the processor determines that the vehicle 20 is driving on the lane line, it can be determined that the vehicle 20 has deviated from the driving lane. The processor can further determine the vibration of the right wheel or the left wheel of the vehicle based on the vibration data of the vehicle 20. If the right wheel of the vehicle vibrates, it means that the right wheel of the vehicle 20 is driving on the lane line, as shown in FIG. 4. If the left wheel of the vehicle vibrates, it means that the left wheel of the vehicle 20 is driving on the lane line, as shown in FIG. 5.

In this embodiment, the vibration data of the vehicle is used to determine the vibration frequency of the vehicle. When the vehicle is driving on the lane line, the vibration frequency may remain in a predetermined frequency range. Therefore, based on the vibration frequency of the vehicle, it can be determined whether the vehicle is driving on the lane line. When it is determined that the vehicle is driving on the lane line, it can be determined that the vehicle is deviating from the driving lane.

An embodiment of the present disclosure provides a warning system for vehicle deviation. On the basis on the foregoing embodiment, determining whether the vehicle deviated from the driving lane based on the vibration data may include determining whether the vehicle is driving on the lane line based on at least one of the lane information of the lane where the vehicle is positioned and the driving information of the vehicle, and the vibration data; and determining that the vehicle deviated from the driving lane if the vehicle is driving on the lane line. The lane information may be determined based on the image data of the lane where the vehicle is positioned, detected by the visual sensor on the vehicle. The driving information of the vehicle may be determined based on the speed sensor and the inertial measurement device on the vehicle.

In this embodiment, the vehicle 20 as described in the foregoing embodiments may also be equipped with an imaging device, which can collect image information of the surrounding environment of the vehicle 20 in real time. For example, the imaging device may collect image information of the lane where the vehicle 20 is positioned in real time. The processor in the warning system may communicate with the imaging device, obtain the image information collected by the imaging device in real time, and further determine the lane information of the lane where the vehicle 20 is positioned based on the image information. In some embodiments, the lane information may include the lane type. The types of lanes may include straight lanes, skewed lanes, and curve lanes. In one embodiment, the lane departure warning function may be turned off. The lane departure warning function may be turned on when it is determined that the surroundings are in a low visibility environment based on the lane image information collected by the imaging device. Low visibility environments may include, but are not limited to, rain, snow, fog, haze, or dark, low-light environments, etc.

In addition, the vehicle 20 may also include a speed sensor. The speed sensor can detect the driving speed of the vehicle 20 in real time, and the processor of the warning system can determine the driving information of the vehicle based on the speed sensor and the inertial measurement device. In some embodiments, the driving information of the vehicle may include at least one of the driving speed and the acceleration of the vehicle.

For example, when the vehicle 20 is driving on a straight lane line, the two wheels on the same side of the vehicle 20 may be in contact with each protrusion on the lane line; and when the vehicle 20 is driving on a curve lane line, one of the wheels of the vehicle 20 may be in contact with a part of the protrusions on the lane line. Therefore, when the vehicle 20 is driving on lane lines of different types of lanes, the vibration data of the vehicle 20 detected by the processor may also be different.

In another example, when the vehicle 20 is driving on the same type of lane, such as a straight lane, the vehicle 20 may be moving at different speeds or accelerations, the vibration amplitude and frequency of the vehicle 20 may also be different. For example, when the vehicle 20 moves at a higher speed, the vibration amplitude and frequency of the vehicle 20 may be higher; when the moves at a lower speed, the vibration amplitude and frequency of the vehicle 20 may be lower.

Therefore, in this embodiment, when the processor determines whether the vehicle 20 deviated from the driving lane based on the vibration data of the vehicle 20, at least one of the type of lane where the 20 is positioned, the driving speed of the vehicle 20, and the vibration data of the vehicle 20 may be combined to determine whether the vehicle 20 is driving on the lane line with protrusions.

In some embodiments, determining whether the vehicle is driving on the lane line based on at least one of the lane information of the lane where the vehicle is positioned and the driving information of the vehicle, and the vibration data may include several implementation methods.

In one implementation method, if the vehicle is driving on a predetermined type of lane and the vibration frequency of the vehicle is within the predetermined frequency range, the vehicle may be determined to be driving on the lane line.

More specifically, if the processor determines that the vehicle 20 is driving in a straight lane and the vibration frequency of the vehicle 20 matches the vibration frequency of the two wheel s on the same side of the vehicle 20, the vehicle 20 may be determined to be driving on the lane line. If the processor determines that the vehicle 20 is driving in a curved lane and the vibration frequency of the vehicle 20 matches the vibration frequency of one wheel of the vehicle 20, the vehicle 20 may be determined to be driving on the lane line.

In another implementation method, if the driving speed of the vehicle is within a predetermined speed range and the vibration frequency of the vehicle is within the predetermined frequency range, the vehicle may be determined to be driving on the lane line.

For example, after the processor obtains the driving speed of the vehicle 20 through the speed sensor, the processor can determine whether the driving speed of the vehicle 20 is with the predetermined speed range. In addition, the vibration frequency of the vehicle 20 may be determined based on the vibration data corresponding to the vehicle 20. When the vehicle 20 is driving on the lane line with protrusions, different driving speeds may cause the vibration frequency of the vehicle 20 to be different. Therefore, if the driving speed of the vehicle 20 is within the predetermined speed range and the vibration frequency of the vehicle 20 is within the predetermined frequency range corresponding to the driving speed, the vehicle may be determined to be driving on the lane line.

In another implementation method, if the vehicle is driving on a predetermined type of lane, the driving speed of the vehicle is within the predetermined speed range, and the vibration frequency of the vehicle is within the predetermined frequency range, the vehicle may be determined to be driving on the lane line.

For example, if the process determines that the vehicle 20 is driving on a straight line, the speed of the vehicle 20 is within the predetermined speed range, and the vibration frequency of the vehicle 20 is within of the predetermined frequency range corresponding to the driving speed, then the vehicle 20 may be determined to be driving on the lane line.

In this embodiment, by determining whether the vehicle is driving on the lane line based on at least one of the lane information and the driving information, and the vibration data, the accuracy of detecting vehicle deviation can be improved.

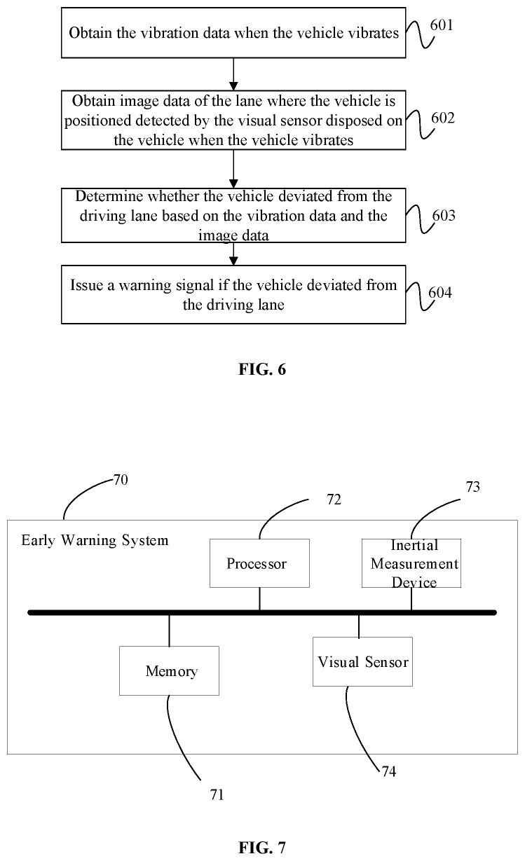

An embodiment of the present disclosure provides a warning method for vehicle deviation. FIG. 6 is a flowchart of the warning method for vehicle deviation according to another embodiment of the present disclosure. As shown in FIG. 6, on the basis of the embodiment shown in FIG. 1, the method in this embodiment may include the following processes.

601, obtaining the vibration data when the vehicle vibrates.

The implementation method and principle of the process at 601 are consistent with the implementation method and principle of the process at 101, and will not be repeated here.

602, obtaining image data of the lane where the vehicle is positioned detected by the visual sensor disposed on the vehicle when the vehicle vibrates.

In this embodiment, a visual sensor may be disposed on the vehicle. The visual sensor may be the imaging device described in the foregoing embodiment, and the imaging device may collect image information of the surrounding environment of the vehicle in real time, such as image information of the lane where the vehicle is positioned. The processor in the vehicle warning system may be configured to receive the detection signal of the inertial measurement device and the image information collected by the imaging device in real time. When the processor determines that the vehicle is vibrating based on the detection signal of the inertial measurement device, it may obtain the image information collected by the imaging device at that time.

603, determining whether the vehicle deviated from the driving lane based on the vibration data and the image data.

The processor may determine whether the vehicle deviated from the driving lane based on the vibration data of the vehicle and the image data collected by the imaging device at the time when the vehicle vibrates. For example, the processor may determine the vibration frequency of the vehicle based on the vibration data of the vehicle, and the vibration frequency of the vehicle match the vibration frequency of the vehicle driving on the lane line, in order to determine whether the vehicle is really driving on the lane line, the processor may combine the image information collected by the imaging device to determine whether the image information includes protrusions and/or lane lines. If the image information includes protrusions and/or lane lines, the vehicle may be determined to be deviating from the driving lane.

In one embodiment, the basic information of the lane where the vehicle is positioned may be obtained based on the imaging device. For example, the lane line and the interval range of the protrusions on it may be [S1, S2]. The size of the interval may be obtained based on, for example, the principle of multi-eye imaging of the imaging system. On this basis, based on the current speed V of the vehicle, the vibration frequency range [V/S2, V/S1] generated by the vehicle when the vehicle is driving on the protrusions on the lane line may be calculated.

In one embodiment, the vibration frequency range generated by the vehicle may be obtained based on historical data, and the historical data may be obtained from the road information in the electronic map of the vehicle's positioning information. For example, based on the vehicle positioning information, the road on which the vehicle is positioned may be road A can be obtained. At the same time, based on the historical information recorded in the electronic map, the range of the protrusion interval on road A may be [S3, S4]. As such, combined with the speed V of the vehicle, the frequency range of the vibration generated by the vehicle [V/S4, V/S3] may be calculated when the vehicle is in contact with the protrusions on the lane line. The vehicle positioning information may be obtained through satellite positioning device, such as Beidou or GPS.

In one embodiment, after determining that the vehicle has deviated from the vehicle's vibration frequency, the relative position relationship between the on-board/inertial navigation device and the electronic map may be used to confirm the determination. More specifically, after determining that the vehicle has deviated from the vehicle vibration information, determine whether the vehicle direction output by the inertial navigation device is consistent with the road direction of the electronic map, if not, the vehicle may be determined to be deviating from the driving lane.

604, issuing a warning signal if the vehicle deviated from the driving lane.

When the processor determines that the vehicle has deviated from the driving lane, the processor may send a control signal to the warning device of the warning system, such as a display, a buzzer, etc., such that the warning device can send a warning signal. For example, the display may display the prompt information of the vehicle deviating from the driving lane, or the buzzer may sound to remind the driver that the vehicle has deviated from the driving lane.

In this embodiment, the vehicle's warning system can obtain the vibration data when the vehicle vibrates and the image information collected by the imaging device at the time of vibration to determine whether the vehicle has deviated from the driving lane, thereby improving the warning accuracy of the warning system for vehicles deviating from the driving lane.

An embodiment of the present disclosure provides a vehicle assisted driving method. The method will be described in detail below.

701, obtaining the vibration data when the vehicle vibrates.

The implementation method and principle of the process at 701 are consistent with the implementation method and principle of the process at 101, and will not be repeated here.

702, determining whether the vehicle deviated from the driving lane based on the vibration data.

The implementation method and principle of the process at 702 are consistent with the implementation method and principle of the process at 102, and will not be repeated here.

In this embodiment, the vibration data when the vehicle vibrates can be obtained, and based on the vibration data, whether the vehicle deviated from the driving lane may be determined. Since there are protrusions on the corresponding lane line of the lane where the vehicle is positioned, when the vehicle is in contact with the protrusions, it means that the vehicle has deviated from the driving lane. Since the vibration data can be obtained when the vehicle vibrates is not affected by the weather, when there is rain or snow or a lane with low visibility, the vibration data can still be obtained normally to determine whether the vehicle deviated from the driving lane, thereby improving the reliability of the vehicle assisted driving functions.

An embodiment of the present disclosure provides a warning system for vehicle deviation. FIG. 7 is a structural diagram of a warning system for vehicle deviation according to an embodiment of the present disclosure. As shown in FIG. 7, a warning system for vehicle deviation 70 includes a memory 71 and a processor 72. The memory 71 stores computer program code, and the processor 72 may be configured to call the program code, when the program code is executed, causes the processor 72 to obtain vibration data when the vehicle vibrates; determine whether the vehicle deviated from the driving lane based on the vibrate data; and issue a warning signal if the vehicle deviated from the driving lane.

In some embodiments, when determining whether the vehicle deviated from the driving lane based on the vibrate data, the processor 72 may determine the vibration frequency of the vehicle based on the vibration data; determine whether the vehicle is driving on the lane line based on the vibration frequency of the vehicle; and determine that the vehicle deviated from the lane line if the vehicle is driving on the lane line.

In some embodiments, when determining whether the vehicle is driving on the lane line based on the vibration frequency of the vehicle, the processor may determine that the vehicle is driving on the lane line if the vibration frequency of the vehicle is within the predetermined frequency range.

In some embodiments, when determining whether the vehicle deviated from the driving lane based on the vibration data, the processor 72 may determine whether the vehicle is driving on the lane line based on at least one of the lane information of the lane where the vehicle is positioned and the driving information of the vehicle, and the vibration data; and determine that the vehicle has deviated from the driving lane if the vehicle is driving on the lane line.

In some embodiments, the lane information may be determined based on the image data of the lane where the vehicle is positioned detected by the visual sensor on the vehicle. The driving information of the vehicle may be determined based on the speed sensor and the inertial measurement device on the vehicle.

In some embodiments, the lane information may include the lane type.

In some embodiments, the driving information of the vehicle may include at least the driving speed and acceleration of the vehicle.

In some embodiments, when determining whether the vehicle is driving on the lane line based on at least one of the lane information of the lane where the vehicle is positioned and the driving information of the vehicle, and the vibration data, the processor 72 may determine that the vehicle is driving on the lane line if the vehicle is driving on a predetermined type of lane and the vibration frequency of the vehicle is within the predetermined frequency range.

In some embodiments, when determining whether the vehicle is driving on the lane line based on at least one of the lane information of the lane where the vehicle is positioned and the driving information of the vehicle, and the vibration data, the processor 72 may determine that the vehicle is driving on the lane line if the driving speed of the vehicle is within the predetermined speed range and the vibration frequency of the vehicle is within the predetermined frequency range.

In some embodiments, when determining whether the vehicle is driving on the lane line based on at least one of the lane information of the lane where the vehicle is positioned and the driving information of the vehicle, and the vibration data, the processor 72 may determine that the vehicle is driving on the lane line if the vehicle is driving on the predetermined type of lane, the diving speed of the vehicle is within the predetermined speed range, and the vibration frequency of the vehicle is within the predetermined frequency range.

In some embodiments, the warning system 70 include an inertial measurement device 73 electrically connected to the processor 72. When obtaining the vibration data when the vehicle vibrates, the processor 72 may determine the vibration data when the vehicle vibrates based on the detection signal of the inertial measurement device on the vehicle.

In some embodiments, the inertial measurement device may be disposed on the suspension of the vehicle wheel.

In some embodiments, the warning system 70 include a visual sensor 74 electrically connected to the processor 72. The processor 72 may be configured to obtain the image data of the lane where the vehicle is positioned when the vehicle vibrates. When determining whether the vehicle deviated from the driving lane based on the vibration data, the processor 72 may determine whether the vehicle deviated from the driving lane based on the vibration data and the image data.

The specific principles and implementation methods of the warning system provided by the embodiment of the present disclosure are similar to those in the foregoing embodiments, and will not be repeated here.

In this embodiment, the vibration data can be obtained when the vehicle vibrates. Based on the vibration data, whether the vehicle deviated from the driving lane may be determined. Since there are protrusions on the corresponding lane line of the lane where the vehicle is positioned, when the vehicle is in contact with the protrusions, it means that the vehicle has deviated from the driving lane and a warning sign can be issued at this time. Since the warning system can obtain the vibration data can be when the vehicle vibrates is not affected by the weather. When there is rain or snow or a lane with low visibility, the warning system can still normally obtain the vibration data of the vehicle to determine whether the vehicle has deviated from the driving lane, which can improve the warning accuracy of the warning system for vehicles deviating from the driving lane.

An embodiment of the present disclosure provides a device for vehicle driving assistance. The vehicle driving assistance device may include a memory and a processor. The memory stores computer program code, and the processor may be configured to call the program code, when the program code is executed, causes the processor to obtain vibration data when the vehicle vibrates; determine whether the vehicle deviated from the driving lane based on the vibrate data.

The specific principles and implementation methods of the vehicle driving assistance device provided by the embodiment of the present disclosure are similar to those in the foregoing embodiments, and will not be repeated here.

In this embodiment, the vibration data when the vehicle vibrates can be obtained, and based on the vibration data, whether the vehicle deviated from the driving lane may be determined. Since there are protrusions on the corresponding lane line of the lane where the vehicle is positioned, when the vehicle is in contact with the protrusions, it means that the vehicle has deviated from the driving lane. Since the vibration data can be obtained when the vehicle vibrates is not affected by the weather, when there is rain or snow or a lane with low visibility, the vibration data can still be obtained normally to determine whether the vehicle deviated from the driving lane, thereby improving the reliability of the vehicle assisted driving functions.

An embodiment of the present disclosure provides a vehicle. The vehicle may include a body; a power system disposed on the body to provide driving power; and the warning system for vehicle deviation and/or the vehicle driving assistance device described in the foregoing embodiments.

In addition, an embodiment of the present disclosure further provides a computer-readable storage medium. The computer-readable storage medium can store instructions that, when executed by the processor, can implement the warning method for vehicle deviation described in the foregoing embodiments.

In the several embodiments provided by the present disclosure, it should be understood that the disclosed apparatus and method may be implemented in other manners. For example, the apparatus embodiments described above are merely illustrative. For example, the unit division is merely logical function division and there may be other division in actual implementation. For example, multiple units or components may be combined or integrated into another system, or some features can be omitted or not be executed. In addition, the mutual coupling or the direct coupling or the communication connection as shown or discussed may be indirect coupling or communication connection through some interfaces, devices or units, and may be in electrical, mechanical or other forms.

The units described as separate components may or may not be physically separated. The components displayed as units may or may not be physical units, that is, may be located in one place or may also be distributed to multiple network units. Some or all of the units may be selected according to actual needs to achieve the objectives of the solution in the disclosure.

In addition, each functional unit in each embodiment of the present disclosure may be integrated into one processing unit, or each unit may exist alone physically, or two or more units may be integrated in one unit. The above-mentioned integrated unit can be implemented in the form of hardware or in the form of hardware plus software functional unit.

The above-described integrated unit implemented in the form of a software functional unit may be stored in a computer-readable storage medium. The software function unit is stored in a storage medium and includes several instructions for enabling a computer device (which may be a personal computer, a server, a network device, etc.) or a processor to execute some steps of the method according to each embodiment of the present disclosure. The foregoing storage medium includes a medium capable of storing computer program code, such as a USB flash disk, a removable hard disk, a read-only memory (ROM), a random access memory (RAM), a magnetic disk, an optical disc, or the like.

Those skilled in the art may clearly understand that, for convenience and brevity of description, the division of the foregoing functional modules is only used as an example. In practical applications, however, the above function allocation may be performed by different functional modules according to actual needs. That is, the internal structure of the device is divided into different functional modules to accomplish all or part of the functions described above. For the working process of the foregoing apparatus, reference may be made to the corresponding process in the foregoing method embodiments, and details are not described herein again.

Finally, it should be noted that the foregoing embodiments are merely intended for describing the technical solutions of the present disclosure, but not to limit the present disclosure. Although the present disclosure is described in detail with reference to the foregoing embodiments, it should be understood by those of ordinary skill in the art that the technical solutions described in the foregoing embodiments may still be modified, or a part or all of the technical features may be equivalently replaced without departing from the spirit and scope of the present disclosure. As a result, these modifications or replacements do not make the essence of the corresponding technical solutions depart from the scope of the technical solutions of the present disclosure.

What is claimed is:

1. A method for vehicle deviation warning, comprising:
obtaining vibration data when a vehicle vibrates;
determining whether the vehicle deviated from a driving lane based on the vibration data; and
issuing a warning signal if the vehicle deviated from the driving lane.

2. The method of claim 1, wherein determining whether the vehicle deviated from the driving lane based on the vibration data includes:
determining a vibration frequency of the vehicle based on the vibration data;
determining whether the vehicle is driving on a lane line based on the vibration frequency; and
determining that the vehicle deviated from the driving lane if the vehicle is driving on the lane line.

3. The method of claim 2, wherein determining whether the vehicle is driving on the lane line based on the vibration frequency includes:
determining that the vehicle is driving on the lane line if the vibration frequency of the vehicle is within a predetermined frequency range.

4. The method of claim 1, further comprising:
determining whether the vehicle is driving on the lane line based on one or more of lane information of the lane where the vehicle is positioned or driving information of the vehicle, and the vibration data; and
determining that the vehicle deviated from the driving lane if the vehicle is driving on the lane line.

5. The method of claim 4, wherein:
the lane information is determined based on image data of the lane where the vehicle is positioned detected by a visual sensor on the vehicle; and
the driving information of the vehicle is determined based on a speed sensor and an inertial measurement device on the vehicle.

6. The method of claim 4, wherein:
the lane information includes a lane type.

7. The method of claim 4, wherein:
the driving information of the vehicle includes one or more of a driving speed or an acceleration of the vehicle.

8. The method of claim 4, wherein determining whether the vehicle is driving on the lane line based on one or more of the lane information of the lane where the vehicle is positioned or the driving information of the vehicle, and the vibration data includes:
determining that the vehicle is driving on the lane line if the vehicle is driving on a predetermined lane type and the vibration frequency is within the predetermined frequency range.

9. The method of claim 4, wherein determining whether the vehicle is driving on the lane line based on one or more of the lane information of the lane where the vehicle is positioned or the driving information of the vehicle, and the vibration data includes:
determining that the vehicle is driving on the lane line if the driving speed of the vehicle is within a predetermined speed range and the vibration frequency of the vehicle is within the predetermined frequency range.

10. The method of claim 4, wherein determining whether the vehicle is driving on the lane line based on one or more of the lane information of the lane where the vehicle is positioned or the driving information of the vehicle, and the vibration data includes:
determining that the vehicle is driving on the lane line if the driving lane is of the predetermined lane type, the driving speed of the vehicle is within the predetermined speed range, and the vibration frequency of the vehicle is within the predetermined frequency range.

11. The method of claim 1, wherein obtaining the vibration data when the vehicle vibrates includes:
determining the vibration data when the vehicle vibrates based on a detection signal of the inertial measurement device on the vehicle.

12. The method of claim 11, wherein:
the inertial measurement device is disposed on a suspension of vehicle wheels.

13. The method of claim 11, further comprising:
obtaining the image data of the lane where the vehicle is positioned detected by the visual sensor disposed on the vehicle when the vehicle vibrates; and
determining whether the vehicle deviated from the driving lane based on the vibrations data including:
determining whether the vehicle deviated from the driving lane based on the vibration data and the image data.

14. A vehicle deviation warning system , comprising:
a processor; and
a memory storing computer programs that, when executed by the processor, the computer programs cause the processor to:
obtain vibration data when a vehicle vibrates;
determine whether the vehicle deviated from a driving lane based on the vibration data; and
issue a warning signal if the vehicle deviated from the driving lane.

15. The warning system of claim 14, wherein the processor determining the whether the vehicle deviated from the driving lane based on the vibration data includes:
determining a vibration frequency of the vehicle based on the vibration data;
determining whether the vehicle is driving on a lane line based on the vibration frequency; and
determining that the vehicle deviated from the driving lane if the vehicle is driving on the lane line.

16. The warning system of claim 15, wherein the processor determining whether the vehicle is driving on the lane line based on the vibration frequency of the vehicle includes:
determining that the vehicle is driving on the lane line if the vibration frequency of the vehicle is within a predetermined frequency range.

17. The warning system of claim 14, wherein the processor determining whether the vehicle deviated from the driving lane based on the vibration data includes:
determining whether the vehicle is driving on the lane line based on one or more of lane information of the lane where the vehicle is positioned or driving information of the vehicle, and the vibration data; and
determining that the vehicle deviated from the driving lane if the vehicle is driving on the lane line.

18. The warning system of claim 17, wherein:
the lane information is determined based on image data of the lane where the vehicle is positioned detected by a visual sensor on the vehicle; and
the driving information of the vehicle is determined based on a speed sensor and an inertial measurement device on the vehicle.

19. The warning system of claim 17, wherein the processor determining whether the vehicle is driving on the lane line based on one or more of the lane information of the lane where the vehicle is positioned or the driving information of the vehicle, and the vibration data includes:
determining that the vehicle is driving on the lane line if the driving vehicle is of a predetermined lane type and the vibration frequency is within the predetermined frequency range.

20. A device for vehicle driving assistance, comprising:
a processor; and
a memory storing computer programs that, when executed by the processor, causes the processor to:
obtain vibration data when a vehicle vibrates; and
determine whether the vehicle deviated from a driving lane based on the vibration data.
